(19) United States
(12) Patent Application Publication
(10) Pub. No.: US 2006/0265453 A1
(43) Pub. Date: Nov. 23, 2006

(54) METHOD AND SYSTEM OF APPLYING A TEMPLATE TO A MESSAGE

(75) Inventors: David L. Kaminsky, Chapel Hill, NC (US); David M. Ogle, Cary, NC (US)

Correspondence Address: MOORE & VAN ALLEN, PLLC, P.O. Box 13706, Research Triangle Park, NC, 27709, US

(73) Assignee: INTERNATIONAL BUSINESS MACHINES CORPORATION, Armonk, NY (US)

(21) Appl. No.: 10/908,614

(22) Filed: May 19, 2005

(51) Int. Cl. G06F 15/16

(52) U.S. Cl. 709/206

(57) ABSTRACT

A method, system and computer program product of applying a template to a message may include automatically applying a template of a set of templates to the message in response to a recipient having been assigned one or more templates from the set of templates.

### BACKGROUND OF THE INVENTION

The present invention relates to electronic messaging, e-mail, instant messaging, and the like, and more particularly to a method and system of applying a template to an electronic message.

There are various forms of electronic messaging (hereinafter “message”, “messages”, or “messaging”), which is a very common form of communication. One form of messaging is E-mail, which allows a user to quickly and easily send a communication to a recipient. Another form of messaging is instant messaging, which allows users to communicate in real time.

These messaging forms also allow a user to customize the appearance of the communication, before it is sent to an intended recipient. The user may manually select a template for customizing a message for the recipient. When composing a message, a user may desire to include a specific template for a designated recipient or content.

Currently, a user may not pre-configure a set of templates that may be automatically applied to a message. With currently known systems, a user is required to manually select a template while composing a message.

### BRIEF SUMMARY OF THE INVENTION

In accordance with an embodiment of the present invention, a method of applying a template to a message may include automatically applying a template of a set of templates to the message in response to a recipient having been assigned at least one of the set of templates.

In accordance with another embodiment of the present invention, a system of applying a template to a message may include a processor. The system may also include a data structure operable on the processor to automatically apply a template of a set of templates to the message in response to a recipient having been assigned at least one of the set of templates. The system may also include a data structure operable on a processor to apply any rules to automatically apply templates.

In accordance with another embodiment of the present invention, a computer program product of applying a template to a message may include a computer readable medium having computer readable program code embodied therein. The computer readable medium may include computer readable program code configured to automatically apply a template of a set of templates to the message in response to a recipient having been assigned at least one of the set of templates.

Other aspects and features of the present invention, as defined solely by the claims, will become apparent to those ordinarily skilled in the art upon review of the following non-limited detailed description of the invention in conjunction with the accompanying figures.

### BRIEF DESCRIPTION OF THE SEVERAL VIEWS OF THE DRAWINGS

FIGS. 1A and 1B (collectively FIG. 1) are a flow chart of an example of a method to automatically apply a template to a message in accordance with an embodiment of the present invention.

FIG. 2 is a flow chart of an example of a method of caching templates in accordance with an embodiment of the present invention.

FIGS. 3A and 3B are an example of a sequence of screen shots or the like illustrating an example of automatically applying templates to a message in accordance with an embodiment of the present invention.

FIG. 4 is a block diagram of an exemplary system for automatically applying a template to a message in accordance with an embodiment of the present invention.

### DETAILED DESCRIPTION OF THE INVENTION

As will be appreciated by one of skill in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects all generally referred to herein as a “circuit”, “module,” or “system.” Furthermore, the present invention may take the form of a computer program product on a computer-usable storage medium having computer-usable program code embodied in the medium.

Any suitable computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device.

Computer program code for carrying out operations of the present invention may be written in an object oriented programming language such as Java, Smalltalk or C++, or the like. However, the computer program code for carrying out operations of the present invention may also be written in conventional procedural programming languages, such as the “C” programming language, or a similar language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a public purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The following detailed description of preferred embodiments refers to the accompanying drawings, which illustrate specific embodiments of the invention. Other embodiments having different structures and operations do not depart from the scope of the present invention.

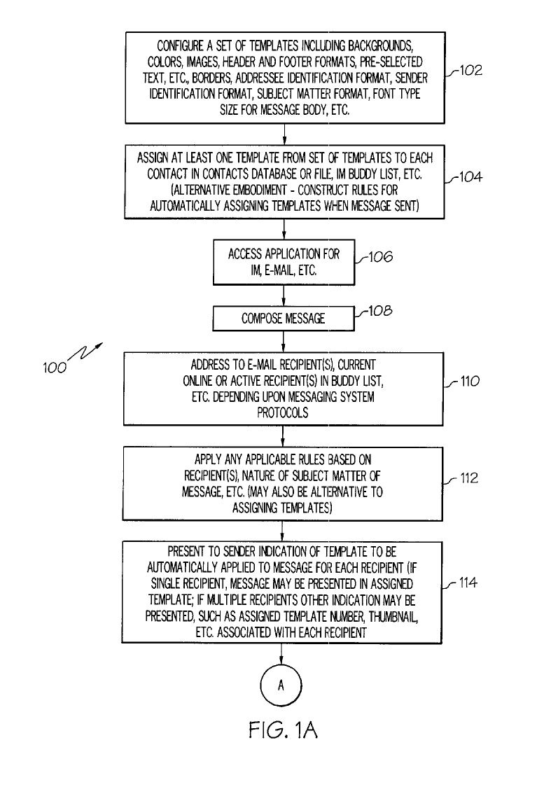

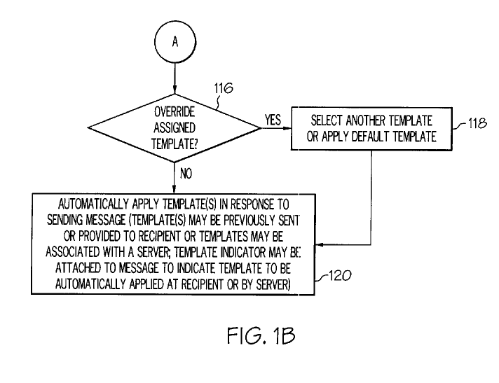

FIGS. 1A and 1B (collectively FIG. 1) are a flow chart of an example of a method 100 for automatically applying a template to an electronic message in accordance with an embodiment of the present invention. In block 102 a set of templates may be created or configured. The configuring may include customizing each template's background or stationery appearance, color, font type and size and image. The configuring may also include customizing header and footer formats, borders, pre-selected text, formatting identification of an addressee or sender, formatting subject matter information in a subject matter block or customization of any other appearance features or elements.

In block 104, the user may assign at least one template from the set of templates to at least one potential message recipient. A default template may be assigned to a message recipient in response to the user not assigning a template from the set of templates. A potential message recipient's e-mail address may be stored as a contact in a database, file or the like. A potential message recipient may also include an entry in an instant messaging “buddy list”, or the like. A buddy list may include instant messaging users whom a user desires to track.

In block 106, the user may access an application or program to compose a message (e-mail, instant message or other type electronic message) and transmit the message via a network to an intended recipient or recipients. The message composition and transmission application or program may be operable on a communication device, such as a computer system, a personal digital assistant, a cellular phone, or similar device capable of electronic messaging (e-mail, instant messaging, or the like). In block 108, a new e-mail, a reply to an e-mail, an e-mail to be forwarded, a new instant message, a reply to an instant message or the like may be composed or created. Accordingly, the method 100 of the present invention may apply to any form or nature of e-mail and instant messaging. The message may be composed on a.

In block 110, the message recipient or recipients may be selected. A recipient may include an individual, a group, or an entity. If the user is composing an e-mail, the recipient or recipients may be selected from a contacts directory, database, file, or the like. If the user is composing an instant message, the recipient or recipients may be selected from a buddy list or the like. Accordingly, the messaging application or system may determine the protocols for selecting a message recipient. Alternatively, in cases where the sender is responding to an incoming or received message, the recipient or recipients may be determined automatically from the incoming message.

In block 112 any applicable rules for automatically applying a template to a message may be applied. The rules may be predefined based on a designated recipient or group of recipients, subject matter of the message, or the like. The predefine rules maybe triggered after the designated recipient or designated subject matter is entered in the message. Once triggered, the rule may automatically apply a specified template to the message. Accordingly, templates may be pre-assigned to potential message recipients in a contact list or IM buddy list as well as applying any applicable rules to more appropriately insure that a proper template under certain circumstances is applied. For example, sending a message with a template that connotes an upbeat, jocular tone may be inappropriate when the subject matter or other circumstances call for a more subdued or somber mood.

In an alternate embodiment of the present invention, predefined rules may be utilized to apply the templates to messages rather than also pre-assigning templates to potential message recipients in a contacts list, IM buddy list or similar list. The rules may be based on the same criteria as that previously described.

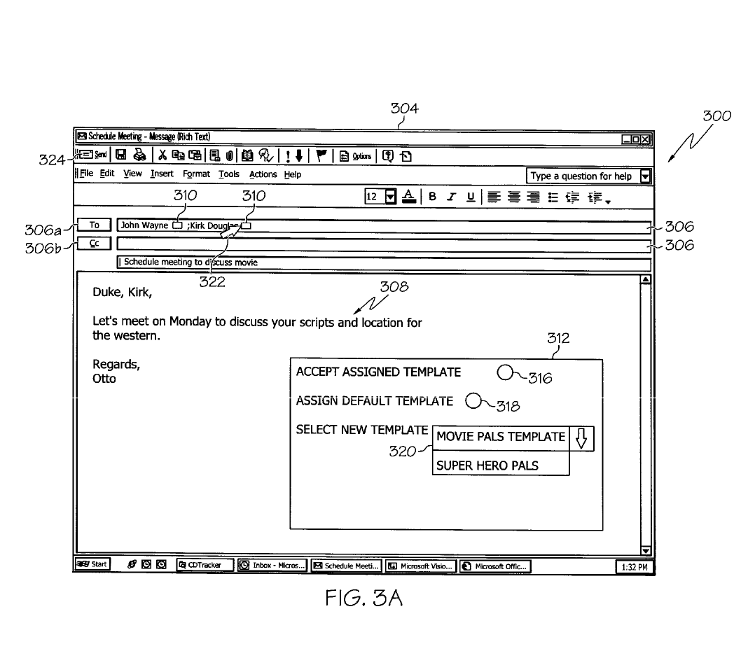

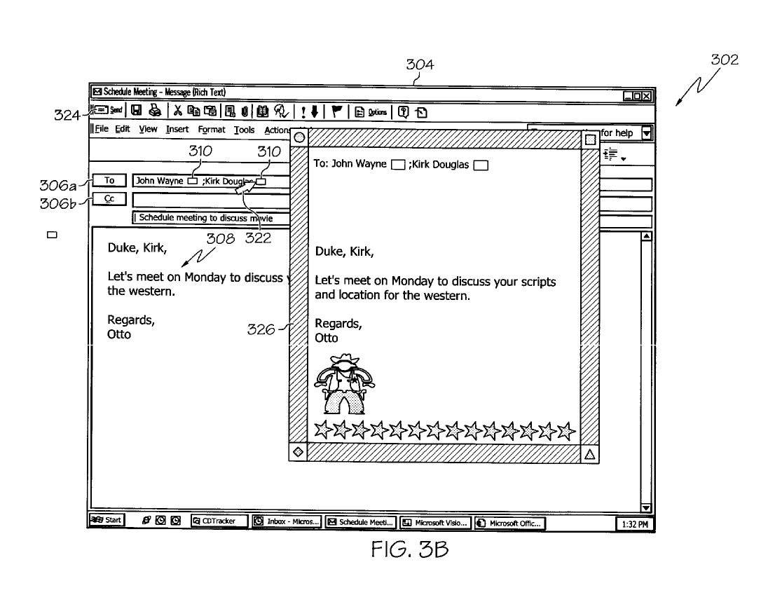

In block 114 a sender may be presented an indication of the template to be automatically applied to the message for each recipient. If the message is being sent to a single recipient, the message may be presented to the sender with the assigned template applied. If the message is being sent to multiple recipients, another indication may be presented to the sender to identify the template being applied or that may be applied to each recipient when sent. For example, an assigned template number, a thumbnail, or other icon or symbol may be associated with each recipient to identify the template that may be assigned. An example of such indications to identify a template to be applied for each recipient is described in more detail with respect to FIGS. 3A and 3B.

In block 116, the sender may be presented an option to override the automatically applied template. An example of presenting such an option will also be described with reference to FIGS. 3A and 3B below. The sender may desire to override the template for a variety of reasons. For example, the template's appearance may not coincide with the content in the message. Similar to the exemplary situation described above with respect to any rules that may override a pre-assigned template, if a template depicting a cheerful tone is automatically applied, the sender may override the applied template if the message content includes a somber tone.

If the user chooses to override the automatically assigned template in block 116, the method 100 may proceed to block 118. In block 118, another template may be selected by the sender or a default template may be applied. As discussed in block 104, the sender may assign multiple templates to a contact. In block 118 the sender may select a different template from a list of templates previously assigned to the recipient or another template from the set of templates may be selected.

If the assigned template is not overridden in block 116, the method 100 may proceed to block 120. In block 120, the assigned template or templates, if multiple recipients with different assigned templates, may be automatically applied in response to the user “sending” the message.

In one embodiment of the present invention, the template or templates assigned to each contact may be stored in the sender's communication device and applied in response to sending the message from the sender's communication device. In another embodiment of the present invention, where storage capacity may limit the storage of multiple templates or other constraints may prevent transmitting a message with an applied template, the assigned template or templates may be previously sent to the recipient or the templates may be stored in association with a server. An indicator of the template to be applied may be attached to the message to identify the template to be automatically applied at the recipient or by the server. The indicator may be a template number, code or similar indication that identifies the template to be applied. In another embodiment of the present invention data that may be used to form the template may be sent separately from the message and then applied to the message when received by the recipient or server.

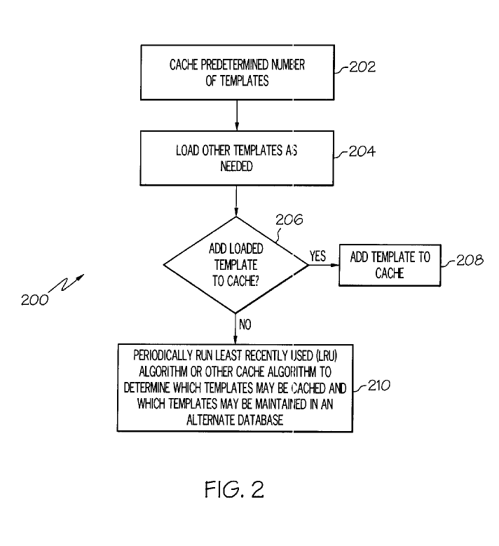

FIG. 2 is a flow chart of an example of a method 200 for caching templates in accordance with an embodiment of the present invention. In block 202, a predetermined number of templates may be cached by a user. In this manner, memory capacity in storage-constrained environments is not occupied by templates that may be rarely used and the more frequently used templates may be readily available for use. A percentage of free memory that may be allocated for template storage may also be set. If the allocated free memory is exceeded, the least used templates may be cached to maintain the preset memory allocation.

In block 204, templates may be loaded as needed that are not in the cache. In block 206, the sender may be offered the option of adding the loaded template to the cache. If the sender elects to cache the template, the template may be added to the cache memory in block 208. If the sender does not elect to cache the loaded template, the method 200 may advance to block 210

In block 210, a Least Recently Used (LRU) algorithm or the like may be periodically run to determine which templates may be cached and which templates may be maintained in an alternate database based on recent usage or frequency of use.

FIGS. 3A and 3B are an example of a sequence of screen shots 300 and 302 illustrating an example of automatically applying templates to a message in accordance with an embodiment of the present invention. The screen shots 300 and 302 illustrate examples of some of the features of the method 100 of FIG. 1. FIG. 3A illustrates a sender composing an e-mail message 304 to multiple recipients. The sender may enter multiple recipients into an address field 306. The address field 306 may include a “To” field 306a, a Carbon Copy (“CC”) field 306b, and a Blind Carbon Copy (“BCC”) field (not shown). The sender may enter or attach any message content 308. The message content may include text, media files, hyperlinks, formatted documents, spreadsheets, executable programs, or the like.

A template indicator 310 may be presented to identify the template to be automatically applied to the message for each recipient. If the message is being sent to only one recipient, the message may be presented in the assigned template, as previously described with respect to the method 100 of FIG. 1. The template indicator 310 may be a template number, a thumbnail representation of the template or other symbol. The template indicator 310 may be associated with the recipient in the address field 306 as illustrated in FIG. 3A.

A pop-up window or dialogue box 312 may be presented to permit a sender to select different options with respect to the templates to be applied to the message for each recipient. Examples of the different options may be a radio button 316 or the like to accept the assigned template; a radio button 318 to assign a default template; a menu or drop-down list 320 to select another template; or similar options. The dialogue box 312 may be displayed in response to contacting the template indicator 310 with a mouse pointer 322 or the like. Alternatively, the dialogue box 312 may be displayed in response to entering a recipient's name in the address field 306 or may be displayed consecutively for each recipient when a send button 324 is operated but before the message is actually transmitted.

Referring to FIG. 3B the template 326 actually applied to the message 304 for each recipient may be displayed by “clicking-on” the template indicator 310 associated with the each recipient. This may facilitate the sender deciding which option to select in dialogue box 312.

While the present invention has been described with respect to an e-mail message in FIGS. 3A and 3B, those skilled in the art will recognize that the features of the present invention may be equally applied to other forms of electronic messaging, such as instant messaging and the like.

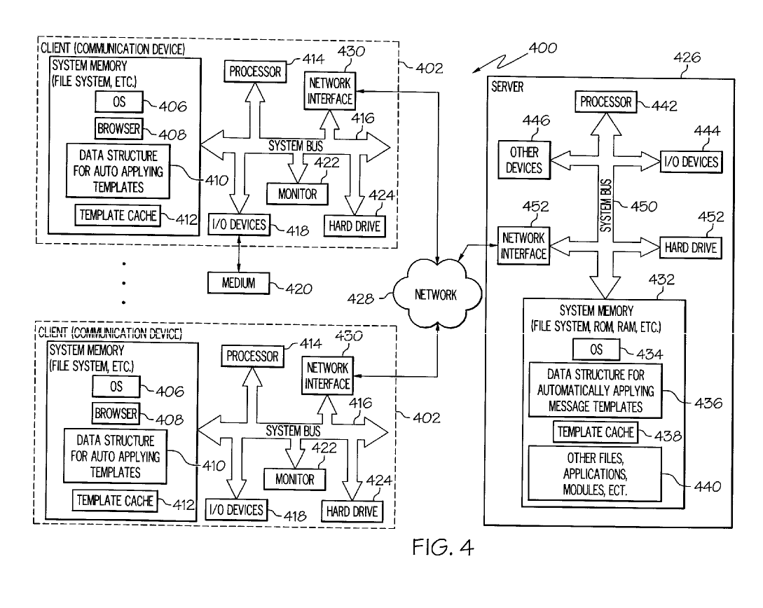

FIG. 4 is a block diagram of an exemplary system 400 to automatically apply at least one template to an electronic message in accordance with an embodiment of the present invention. The elements of the methods 100 and 200 may be embodied in and performed by the system 400. The system 400 may include one or more user or client communication devices 402 or similar systems or devices. Each Communication device 402 may be a computer system, a personal digital assistant, a cellular phone, or similar device capable of sending and receiving an electronic message.

The communication device 402 may include a system memory 404 or local file system. The system memory 404 may include a read only memory (ROM) and a random access memory (RAM). The ROM may include a basic input/output system (BIOS). The BIOS may contain basic routines that help to transfer information between elements or components of the communication device 402. The system memory 404 may contain an operating system 406 to control overall operation of the communication device 402. The system memory 404 may also include a browser 408 or web browser. The system memory 404 may also include data structures 410 or computer-executable code to automatically apply at least one template to an electronic message that may be similar or include elements of the method 100 in FIGS. 1A and 1B and method 200 in FIG. 2. The system memory 404 may further include a template cache memory 412, which may be used in conjunction with the method 200 in FIG. 2 to store most recently used or frequently used templates.

The communication device 402 may also include a processor or processing unit 414 to control operations of the other components of the communication device 402. The operating system 406, browser 408, data structures 410 may be operable on the processor 414. The processor 414 may be coupled to the memory system 404 and other components of the communication device 402 by a system bus 416.

The communication device 402 may also include multiple input devices, output devices or combination input/output devices 418. Each input/output device 418 may be coupled to the system bus 416 by an input/output interface (not shown in FIG. 4). The input and output devices or combination I/O devices 418 permit a user to operate and interface with the communication device 402 and to control operation of the browser 408 and data structures 410 to access, operate and control the software to automatically apply at least one template to an electronic message. The I/O devices 418 may include a keyboard and computer pointing device or the like to perform the operations discussed herein.

The I/O devices 418 may also include disk drives, optical, mechanical, magnetic, or infrared input/output devices, modems or the like. The I/O devices 418 may be used to access a medium 420. The medium 420 may contain, store, communicate or transport computer-readable or computer-executable instructions or other information for use by or in connection with a system, such as the communication devices 402.

The communication device 402 may also include or be connected to other devices, such as a display or monitor 422. The monitor 422 may be used to permit the user to interface with the communication device 402. The monitor 422 may present the screen shots illustrated in FIGS. 3A and 3B that may be generated by the data structures 410 for automatically applying at least one template to an electronic message.

The communication device 402 may also include a hard disk drive 424. The hard drive 424 may be coupled to the system bus 416 by a hard drive interface (not shown in FIG. 4). The hard drive 424 may also form part of the local file system or system memory 404. Programs, software and data may be transferred and exchanged between the system memory 404 and the hard drive 424 for operation of the communication device 402.

The communication devices 402 may communicate with a remote server 426 and may access other servers or other communication devices similar to communication device 402 via a network 428. The system bus 416 may be coupled to the network 428 by a network interface 430. The network interface 430 may be a modem, Ethernet card, router, gateway or the like for coupling to the network 428. The coupling may be a wired connection or wireless. The network 428 may be the Internet, private network, an intranet or the like.

The server 426 may also include a system memory 432 that may include a file system, ROM, RAM and the like. The system memory 432 may include an operating system 434 similar to operating system 406 in communication devices 402. The system memory 432 may also include data structures 436 to automatically apply at least one template to an electronic message. The data structures 436 may include operations similar to those described with respect to the method 100 for automatically applying a template to an electronic message in FIG. 1 and the method 200 for caching recently used or frequently used templates. The server 426 may also include or be associated with a template cache memory 438. Clients, such as communication devices 402 or the like, may access the template cache memory 438 similar to that described with respect to the method 200 in FIG. 2. The server system memory 432 may also include other files 440, applications, modules and the like.

The server 426 may also include a processor 442 or a processing unit to control operation of other devices in the server 426. The server 426 may also include I/O device 444. The I/O devices 444 may be similar to I/O devices 418 of communication devices 402. The server 426 may further include other devices 446, such as a monitor or the like to provide an interface along with the I/O devices 444 to the server 426. The server 426 may also include a hard disk drive 448. A system bus 450 may connect the different components of the server 426. A network interface 452 may couple the server 426 to the network 428 via the system bus 450.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A method of applying a template to a message, comprising automatically applying a template of a set of templates to the message in response to a recipient having been assigned at least one of the set of templates.

2. The method of claim 1, further comprising:
configuring each of the set of templates; and
assigning at least one template from the set of templates to each contact in a contacts list.

3. The method of claim 1, wherein automatically applying the template comprises automatically applying the template to one of an e-mail message and an instant message for transmission in real-time.

4. The method of claim 1, further comprising applying any rules for automatically applying templates.

5. The method of claim 1, further comprising:
presenting the message formatted in the automatically applied template to the sender in response to the message being sent to a single recipient; and
presenting a template indicator in association with each recipient to the sender in response to the message being sent to multiple recipients, wherein the template indicator indicates the template to be automatically applied to the message for each recipient.

6. The method of claim 5, further comprising:
selecting another template for the set of templates in response to overriding the template assigned to any recipient; and
applying a default template in response to overriding the assigned template and not selecting another template.

7. The method of claim 1, further comprising:
providing the at least one template of the set of templates to the recipient separate from the message; and
attaching a template indicator to the message to indicate the template to be automatically applied to the message at the recipient.

8. The method of claim 1, further comprising:
caching the set of templates in association with a server; and
attaching a template indicator to the message to indicate the template to be automatically applied to the message.

9. The method of claim 1, further comprising:
caching a predetermined number of templates; and
loading other templates as needed.

10. The method of claim 9, periodically running an algorithm to determine which templates should be cached and which templates should be maintained in an alternate database.

11. A system of applying a template to a message, comprising:
a processor; and
a data structure operable on the processor to automatically apply a template of a set of templates to the message in response to a recipient having been assigned at least one of the set of templates.

12. The system of claim 11, further comprising a data structure to automatically apply the template to one of an e-mail message and an instant message for transmission in real-time.

13. The system of claim 11, further comprising a data structure to present an indication of the template to be automatically applied to the message for each recipient of a plurality of recipients of the message.

14. The system of claim 9, further comprising:
a data structure to present the message formatted in the automatically applied template to the sender in response to the message being sent to a single recipient; and
a data structure to present a template indicator in association with each recipient to the sender in response to the message being sent to multiple recipients, wherein the template indicator to be automatically applied to the message for each recipient.

15. The system of claim 14, further comprising:
a data structure to select another template from the set of templates in response to overriding the template assigned to any recipient; and
a data structure operable to apply a default template in response to overriding the assigned template and not selecting another template.

16. A computer program product of applying a template to a message comprising:
computer readable medium having computer readable program code embodied therein, the computer readable medium comprising:
computer readable program code configured to automatically apply a template of a set of templates to the message in response to a recipient having been assigned at least one of the set of templates.

17. The computer program product of claim 16, further comprising computer readable program code operable to configure each of the set of templates;
computer readable program code configured to assign at least one template from the set of templates to each contact in a contacts list; and
computer readable program code configured to automatically apply the template to one of an e-mail message and an instant message for transmission in real-time.

18. The computer program product of claim 16, further comprising computer readable program code configured to present an indication of the template to be automatically applied to the message for each recipient of a plurality of recipient of the message.

19. The computer program product of claim 16, further comprising:
computer readable program code configured to present the message formatted in the automatically applied template to the sender in response to the message being sent to a single recipient; and
computer readable program code configured to present a template indicator in association with each recipient to the sender in response to the message being sent to multiple recipients, wherein the template indicator indicates the template to be automatically applied to the message for each recipient.

20. The computer program product of claim 19, further comprising:
computer readable program code configured to select another template from the set of templates in response to overriding the template assigned to any recipient; and
computer readable program code configured to apply a default template in response to the overriding of the assigned template and non-selection of another template.
